(19) United States
(12) Patent Application Publication
(10) Pub. No.: US 2009/0159096 A1
(43) Pub. Date: Jun. 25, 2009

(54) ACID PICKLING SOLUTION AND METHOD FOR SURFACE TREATMENT UTILIZING THE SAME

(75) Inventors: SHENG-EN HSU, Tu-Cheng (TW); YONG LIU, Shenzhen City (CN); FEI-XIANG LI, Shenzhen City (CN); ZHAO JIN, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/168,055

(22) Filed: Jul. 3, 2008

(30) Foreign Application Priority Data
Dec. 19, 2007 (CN) 200710203246.9

(51) Int. Cl. B08B 3/08

(52) U.S. Cl. 134/3; 510/254

(57) ABSTRACT

An exemplary acid pickling solution for treating a surface of a magnesium alloy workpiece. The acid pickling solution consists of 5 g/l to 30 g/l of citric acid, 1.5 g/l to 6 g/l of surface active agent, wherein the surface active agent is a water-soluble and silicone free agent. A method for treating a surface of a magnesium alloy workpiece is also provided.

### CROSS-REFERENCE TO RELATED APPLICATIONS

This application is related to a co-pending U.S. patent applications, applications Ser. No. [to be advised] (Docket No. US16498), entitled “MAGNESIUM ALLOY ARTICLE AND METHOD FOR FABRICATING THE SAME”; applications Ser. No. [to be advised] (Docket No. US16499), entitled “PHOSPHATING SOLUTION AND METHOD FOR CONVERSION TREATING SURFACE OF MAGNESIUM ALLOY WORKPIECE”. In the co-pending applications, the inventors are Sheng-En Hsu, Yong Liu, Fei-Xiang Li and Zhao Jin. Such applications have the same assignee as the present application and have been concurrently filed herewith. The disclosures of the above identified applications are incorporated herein by reference.

### BACKGROUND

1. Field of the Invention

The present invention relates to acid pickling solutions and more specifically to an acid pickling solution and a method for treating magnesium alloy surfaces utilizing the same.

2. Discussion of the Related Art

Magnesium alloys, made up of magnesium and other metals such as aluminum and zinc, have become, in recent years, increasingly in demand in use as structural materials for electronic products and vehicles.

Since magnesium alloy can react easily with other chemical substances such as acids, before a workpiece thereof is used, a phosphating film is generally layered on an outer surface to protect the workpiece.

The phosphating film is formed by conversion treating the surface of the workpiece. Typically, this method includes an acid pickling process to remove oxides and agents (i.e. release agent for mold unloading) from the surface of the magnesium alloy workpiece. However, the acid pickling process easily produces black ash (mainly Al and Zn) on the surface. In subsequent conversion treating of the workpiece, such as chemical conversion, it can be very difficult to completely remove the ash, such that the phosphating film formed is not only non-uniform, but also exhibits black areas accordingly, whereby the appearance of the magnesium alloy does not meet standards of quality.

Thus, an acid pickling solution and method for conversion treating a magnesium alloy surface utilizing the same, that avoids black ash formation, are desired.

### SUMMARY

An acid pickling solution is used to treat a surface of a magnesium alloy workpiece. The acid pickling solution comprises 5 g/l to 30 g/l of citric acid, 1.5 g/l to 6 g/l of surface active agent, wherein the surface active agent is a water-soluble and silicone free agent.

8] A method for treating the surface of a magnesium alloy workpiece comprises degreasing, acid pickling, alkali pickling, and chemical conversion, with an acid pickling solution used comprising: 5 g/l to 30 g/l of citric acid, 1.5 g/l to 6 g/l of surface active agent, with the surface active agent a water-soluble and silicone free agent.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present phosphating solution and method for conversion treating surface of the magnesium alloy workpiece. Moreover, in the drawings, like reference numerals designate corresponding parts throughout several views, and all the views are schematic.

FIG. 1 is a flowchart of a method for conversion treating the surface of a magnesium alloy workpiece in accordance with an exemplary embodiment of the present invention.

FIG. 2 is a table showing parameters of the method of FIG. 1.

FIG. 3 is a table showing recipes for acid pickling solutions, alkaline solutions, and phosphating solutions respectively.

FIG. 4 is a table showing test results of the samples.

### DETAILED DESCRIPTION OF THE PREFERRED EMBODIMENT

Reference will now be made to the drawings to describe preferred embodiments of acid pickling solutions and methods for treating magnesium alloy surfaces utilizing the same, in detail.

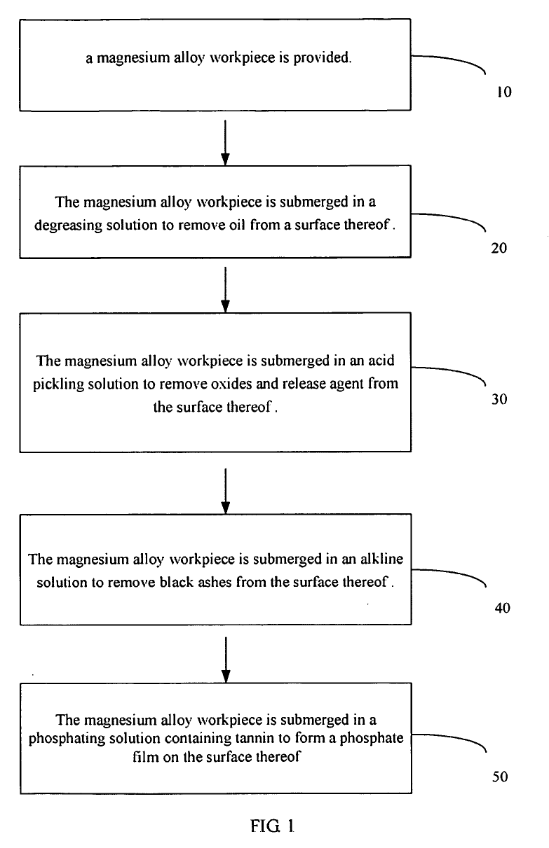

Referring to FIG. 1, a flowchart of a method for conversion treating surface of a magnesium alloy workpiece according to an exemplary embodiment includes the following steps.

In Step 10, a magnesium alloy workpiece is provided. In Step 20, the magnesium alloy workpiece is submerged in a degreasing solution to remove oil or other material from the surface of the magnesium alloy workpiece. Step 30 comprises acid pickling, in which the magnesium alloy workpiece is submerged in an acid pickling solution to remove oxides and release agents from the surface. In Step 40, the magnesium alloy workpiece is submerged in an alkaline solution to remove black ash from the surface. In Step 50, the magnesium alloy workpiece is submerged in a phosphating solution containing tannin to form a phosphate film on the surface thereof.

In step 20, the magnesium alloy workpiece is placed in the degreasing solution for about 4 to 8 minutes, with the temperature of the degreasing solution from about 55° C. to about 65° C. The degreasing solution consists of sodium hydroxide (NaOH) or sodium phosphate (Na3PO4) and water (H2O). It should be noted that, if the magnesium alloy workpiece has been sandblasted, oils or the like on the surface of the magnesium alloy workpiece have already been removed, and step 20 can be omitted.

In step 30, the magnesium alloy workpiece is placed in the acid pickling solution for about 3 minutes to about 5 minutes, with the temperature of the acid pickling solution about 35° C. to 45° C. The acid pickling solution consists of citric acid, surface active agent, and water (H₂O). The surface active agent is water-soluble and silicone-free. Concentration of the citric acid is 5 g/l to 30 g/l. Concentration of the surface active agent (industrial grade) is 1.5 g/l to 6 g/l.

0] The citric acid reacts with and remove oxides and release agent from the surface of the magnesium alloy workpiece. The oxides can be magnesia (MgO), alumina (Al₂O₃), and zinc oxide (ZnO). The release agents include a resin represented by a formula: (CH₂)ₘ—CH(Si)ₙ—COOR, wherein, R represents a functional group such as methyl. The citric acid may also prevent black ash from forming on the surface of the magnesium alloy workpiece to a certain extent. A concentration of the citric acid is 8 g/l to 15 g/l. When the magnesium alloy workpiece is placed into the acid pickling solution, the following chemical reactions occur:

MgO+2H⁺═Mg²⁺+H₂O;

Al₂O₃+6H⁺=2Al³⁺+3H₂O;

ZnO+2H⁺═Zn²⁺+H₂O;

Mg+2H⁺=Mg²⁺+H₂;

(CH₂)ₘ—CH(Si)ₙ—COOR+H⁺═R⁺+(CH₂)ₘ—CH(Si)ₙ—COOH.

The surface active agent may be used as a buffer, so as to prevent excessive corrosion to the magnesium alloy workpiece, and prevent black ash from forming on the surface of the magnesium alloy workpiece further. The surface active agent includes a hydrophilic group, such as a hydroxyl. The surface active agent can be polyethylene glycol, glycerol, neopentyl glycol, sucrose, dextrose, sorbitol, or a combination thereof. Concentration of the surface active agent is 3 g/l to 4 g/l.

In step 40, the magnesium alloy workpiece is placed in the alkaline solution for about 3 minutes to about 5 minutes, with the temperature of the alkaline solution about 60° C. to 80° C. A solute of the alkaline solution can be potassium hydroxide (KOH) or sodium hydroxide (NaOH).

The alkaline solution mainly reacts with and removes the black ash from the surface of the magnesium alloy workpiece such that a base of the magnesium alloy workpiece is exposed. When the solute is KOH (industrial grade), a concentration of the KOH is 60 g/l to 180 g/l. Preferably, a concentration of the KOH is in the range from 100 g/l to 150 g/l. When the magnesium alloy workpiece is placed into the alkaline solution, the following chemical reactions occur:

6KOH+2Al=2K₃AlO₃+3H₂;

2KOH+Zn═K₂ZnO₂+H₂.

In step 50, the magnesium alloy workpiece is placed in the phosphating solution for about 30 seconds to 50 seconds, with the temperature of the phosphating solution about 35° C. to 45° C. Thickness of the phosphating film formed on the surface of the workpiece can be from 5 to 30 μ. Surface resistance of the phosphating film formed on the magnesium alloy workpiece is less than 2 ohm. The phosphating solution can include 2.89 g/l to 8.67 g/l of phosphoric acid (H₃PO₄) (industrial grade), 0.3 g/l to 1.0 g/l of carbamide ((NH₂)₂CO) (Analytical Reagent Grade), 0.39 g/l to 1.56 g/l of nitric acid (HNO₃) (industrial grade), 2 g/l to 30 g/l of manganese dihydrogen phosphate (Mn(H₂PO₄)₂) (industrial grade), and 0.2 g/l to 0.6 g/l of tannin (C₇₆H₅₂O₄₆) (Analytical Reagent Grade).

The H₃PO₄ is used to provide PO₄³⁺ ions. To further regulate a thickness of the phosphating film formed on the surface of the workpiece, the concentration of the H3PO4 is, preferably, from 4.34 g/l to 6.5 g/l.

The (NH2)2CO provides uniform coating of the phosphating film. To prevent the phosphating film from developing/forming too slowly, the concentration of the (NH2)2CO is, preferably, from 0.4 g/l to 0.6 g/l.

The HNO₃ provides H⁺ ions to adjust pH of the phosphating solution from about 6.5 to 9.5. Preferably, the concentration of the HNO₃ is from 0.62 g/l to 0.94 g/l.

The Mn(H2PO4)2 provides Mn2+, PO43+, and H+ ions. To further enhance uniform thickness of the phosphating film on the surface of the workpiece, the concentration of Mn(H2PO4)2 is, preferably, from 10 g/l to 18 g/l.

The tannin improves bonding strength between the phosphating film and a painting layer coated on the phosphating film. Preferably, the concentration of the tannin is from 0.4 g/l to 0.55 g/l.

The phosphating film mainly consists of composite phosphates including Mg₃(PO₄)₂, Mn₃(PO₄)₂, and others. When the magnesium alloy workpiece is placed into the phosphating solution, the following chemical reactions occur;

Mg+2H⁺═Mg²⁺+H₂;

3Mg²⁺+2PO₄³⁻═Mg₃(PO₄)₂;

3Mn²⁺+2PO₄³⁻═Mn₃(PO₄)₂.

The formula of the composite phosphate can be:

(Mg²⁺)_{A}(Mn²⁺)_{B}(NO³⁻)_{C}(Zn²⁺)_{D}(PO₄³⁻)_{E}.

It can be understood that the method can further include a water cleaning step after step 20, step 30, step 40, or step 50 respectively. In addition, the method may include a drying process after step 50. The magnesium alloy workpiece can be dried at a temperature from about 110° C. to about 150° C. for about 30 minutes to about 70 minutes.

Examples of methods for conversion treating surfaces of the magnesium alloy workpieces are described as follows.

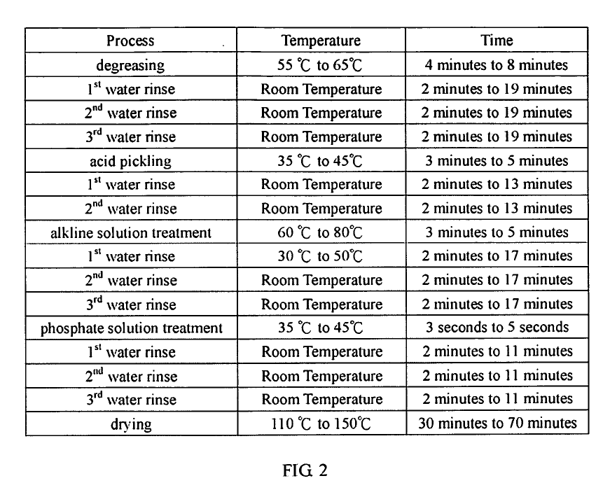

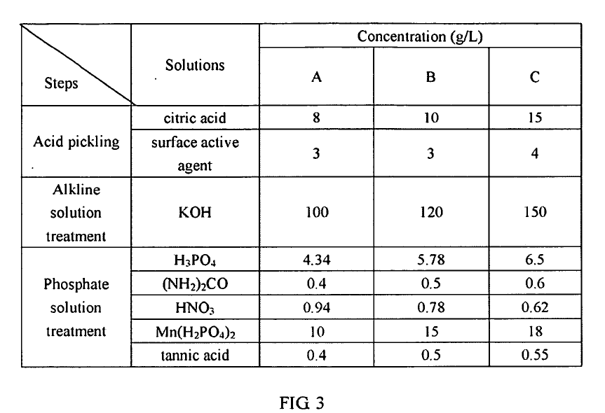

Three groups (1^{st} group, 2^{nd} group, and 3^{rd} group, each including three magnesium alloy workpieces) of magnesium alloy workpieces are provided. A material of each of the magnesium alloy workpiece is AZ91D. The three groups of magnesium alloy workpieces are treated with the processes shown in FIG. 2 correspondingly, thereby yielding three sample groups of magnesium alloy products. As shown in FIG. 3, Recipes (A column, B column, and C column) of acid pickling solutions, alkline treatment solutions, and phosphating solutions are used during the corresponding processes of the three sample groups (1^{st} group, 2^{nd} group, and 3^{rd} group) of magnesium alloy workpiece.

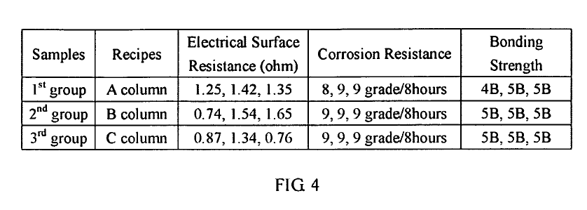

Corrosion resistance of the samples is evaluated by a salt spray tester using solution including 5% of sodium chloride (NaCl). Surface resistance of the samples of the magnesium alloy products is evaluated using micro-ohmmeter. The bonding strength of the samples of the magnesium alloy products is evaluated by performing a cross-cut test after an outer coating is formed on the phosphating film. Referring to FIG. 4, a test result of the samples is shown. Corrosion resistance of the samples of the magnesium alloy products is all above grade 8, surface resistance of the magnesium alloy products is all less than 2 ohms, and the bonding strength of the samples of the magnesium alloy products is all above 3B grade. Therefore, the magnesium alloy products all have good corrosion resistance, relatively high bonding strength, and low surface resistance. It is understood that, if the magnesium alloy products are applied to a portable electronic devices, the portable electronic devices may have a good electromagnetic interference shielding efficiency.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. An acid pickling solution for treating a surface of a magnesium alloy workpiece, the acid pickling solution comprising: 5 g/l to 30 g/l of citric acid, 1.5 g/l to 6 g/l of surface active agent, wherein the surface active agent is water soluble and silicone free.

2. The acid pickling solution for treating a surface of a magnesium alloy workpiece as claimed in claim 1, wherein the surface active agent comprises polyalcohol.

3. The acid pickling solution for treating a surface of a magnesium alloy workpiece as claimed in claim 2, wherein the polyalcohol is polyethylene glycol, glycerol, neopentyl glycol, sucrose, dextrose, sorbitol, or a combination thereof.

4. A method for treating a surface of a magnesium alloy workpiece comprises degreasing, acid pickling, alkali pickling, and chemical conversion in that order, wherein an acid pickling solution applied in the acid pickling process comprises: 5 g/l to 30 g/l of citric acid, 1.5 g/l to 6 g/l of surface active agent, and the surface active agent is water soluble and silicone free.

5. The method of claim 4, wherein the surface active agent comprises polyalcohol.

6. The method of claim 5, wherein the polyalcohol is poly ethylene glycol, glycerol, neopentyl glycol, sucrose, dextrose, sorbitol, or a combination thereof.

7. The method of claim 4, wherein in the acid pickling process, the magnesium alloy workpiece placed in the acid pickling solution takes about 3 minutes to about 5 minutes.

8. The method of claim 4, wherein in the acid pickling process, the temperature of the acid pickling solution is about 35° C. to about 45° C.
